(19) United States
(12) Patent Application Publication
(10) Pub. No.: US 2018/0168399 A1
(43) Pub. Date: Jun. 21, 2018

(54) AUTOMATIC MUDDLER SYSTEM AND COCKTAIL MACHINE COMPRISING SAME

(71) Applicant: BLENDBOW, Neuilly Sur Seine (FR)

(72) Inventor: Morgan FELLOUS, Neuilly Sur Seine (FR)

(21) Appl. No.: 15/741,141

(22) PCT Filed: May 31, 2016
(86) PCT No.: PCT/FR2016/051300

§ 371 Date: Dec. 29, 2017

(30) Foreign Application Priority Data
Jun. 5, 2015 (FR) 1555170

(51) Int. Cl. A47J 43/042; B01F 11/00; A47J 43/044

(52) U.S. Cl. CPC A47J 43/042; A47J 2043/0449; A47J 43/044; B01F 11/0022

(57) ABSTRACT

Disclosed is an automatic muddler system for triturating ingredients in a container, the automatic muddler system including a muddler assembly including a muddler and below which is located a container holding device for holding in position, below the muddler, a container into which the muddler triturates ingredients, the muddler assembly further including a muddler driving block connected to the upper end of the muddler, the muddler driving block including a device for rotating the muddler on itself, a device for vertically moving the muddler, an electronic card configured to control the device for rotating the muddler on itself and the device for vertically moving the muddler, and a power supply. The muddler driving block further includes a muddler tilting device and a device for rotating the muddler tilting device, the muddler tilting device and the device for rotating the muddler tilting device being controlled by the electronic card.

The present invention relates to the field of the machines for triturating ingredients, and particularly relates to an automatic muddler system for triturating ingredients in a container and to a cocktail machine comprising said automatic muddler system.

Many beverages, with or without alcohol, require to triturate ingredients such as sugar or pieces of lemon for their making, this triturating operation being traditionally performed manually by a user handling a muddler in a mortar, or directly in the container intended to contain the beverage. However, such manual triturating operation is not uniform for every beverage and, in the case where the user is a bartender, is time consuming, thereby reducing the number of beverages which can be served by the bartender in a given time. There is thus a need for an automatic muddler system in order to make the operation for triturating the ingredients in a container automatic and uniform and to increase the number of beverages which can be served in a given time by a bartender.

International application PCT WO2014150896 discloses a machine for mixing the ingredients of a beverage, said machine comprising a muddler having at least one head, a driving assembly comprising an electric motor being attached to the upper end of the muddler in order to rotate the muddler on itself and to move it to-and-fro vertically so as to crush ingredients contained in a container, the container being held on the machine by a container support. However, this machine does not allow to reproduce exactly the movement of a bartender, the muddler moving only vertically and in rotation on itself, and not on the entire bottom surface of the container, which does not allow to efficiently and evenly triturate the ingredients contained in the container. In addition, this machine does not allow to mix, by shaking, the ingredients contained in the container once they have been triturated.

The present invention is intended to solve the disadvantages of the prior art by proposing an automatic muddler system for triturating ingredients in a container, said automatic muddler system comprising a container holding device and a muddler driving block comprising a device for rotating the muddler on itself, a device for vertically moving the muddler, a muddler tilting device and a device for rotating the muddler tilting device, said automatic muddler system thus allowing to automatically and evenly triturate the ingredients in the container by reproducing the movement performed by a bartender on the entire bottom surface of the container, thereby allowing to efficiently and evenly triturate the ingredients and to increase the number of beverages which can be served in a given time by a bartender.

The automatic muddler system can also comprise a container shaking device in order to mix, by shaking, the ingredients located in the container once they have been triturated by the muddler.

The present invention also provides a cocktail machine comprising said automatic muddler system.

The present invention thus relates to an automatic muddler system for triturating ingredients in a container, the automatic muddler system comprising a muddler assembly comprising a muddler and below which is located a container holding device for holding in position, below the muddler, a container in which the muddler is intended to triturate ingredients, the muddler assembly further comprising a muddler driving block connected to the upper end of the muddler, the head of the muddler being directed opposite the muddler driving block in the longitudinal direction of the muddler and being configured to move in use in the container held in the container holding device, the muddler driving block comprising a device for rotating the muddler on itself, a device for vertically moving the muddler, an electronic card configured to control the device for rotating the muddler on itself and the device for vertically moving the muddler, and a power supply, characterized in that the muddler driving block further comprises a muddler tilting device and a device for rotating the muddler tilting device, the muddler tilting device and the device for rotating the muddler tilting device being controlled by said electronic card.

The automatic muddler system is thus configured to reproduce the movement performed by a bartender, the device for rotating the muddler on itself and the device for vertically moving the muddler allowing to crush the ingredients contained in the container using the muddler head, the muddler tilting device and the device for rotating the muddler tilting device allowing the muddler head to move on the entire bottom surface of the container, regardless of the shape and of the diameter of the bottom of the container, thereby allowing to automatically, evenly and efficiently triturate the ingredients contained in the container and to increase the efficiency of the bartender or of the user making the beverage.

In addition, the container holding device allows to hold a container in position below the muddler assembly such that, when driving the muddler by the muddler driving block, the container is stationary so as to efficiently triturate the ingredients contained in the container.

The electronic card comprises one of a processor, a microprocessor, a microcontroller, a digital signal processor (DSP), or a programmable logical component such as a field programmable gate array (FPGA) or an application specific integrated circuit (ASIC), and a memory, so as to control the muddler driving block.

According to a particular feature of the invention, the device for rotating the muddler on itself comprises a first electric motor whose rotor is connected to the upper end of the muddler and has a rotation axis corresponding to the longitudinal direction of the muddler so as to rotate the muddler on itself around its longitudinal axis, the first electric motor being controlled by the electronic card.

The rotation of the muddler on itself around its longitudinal axis thus allows to triturate the ingredients contained in the container when the muddler head is lowered on the bottom of the container by the device for vertically moving the muddler.

According to a particular feature of the invention, the device for vertically moving the muddler comprises at least one vertical rod, on which the muddler driving block is able to slide, and a second electric motor whose rotor is connected to a first toothed wheel and whose stator is fixed to the muddler driving block, the first toothed wheel meshing with a stationary vertical rack such that the rotation of the rotor of the second electric motor causes the second electric motor to move along the rack, thereby causing the muddler driving block to slide along the at least one vertical rod, the second electric motor being controlled by the electronic card.

The device for vertically moving the muddler preferably comprises two vertical rods.

The vertical sliding of the muddler driving block along the at least one vertical rod thus allows to lower the muddler head on the bottom of the container and to perform a vertical to-and-fro movement so as to triturate the ingredients contained in the container, whether simultaneously or not with the rotation of the muddler on itself.

According to a particular feature of the invention, the muddler tilting device comprises a third electric motor whose rotor is connected to one of the ends of a hinged arm, the other end of the hinged arm being connected to a connecting member comprising a through hole into which the upper end of the muddler is inserted, such that the rotation of the rotor of the third electric motor causes the muddler head to be tilted, the third electric motor being controlled by the electronic card.

The rotation of the rotor of the third electric motor thus causes the muddler to be tilted from the connecting member driven by the hinged arm, thereby allowing to tilt the muddler head in the container so as to reach the edges of the bottom of the container to triturate the ingredients located on the edges of the container, whether simultaneously or not with the vertical displacement of the muddler and with the rotation of the muddler on itself.

According to a particular feature of the invention, the device for rotating the muddler tilting device comprises a fourth electric motor whose rotor is connected to a second toothed wheel meshing with a third toothed wheel with a central through hole, the second and third toothed wheels being located in a plane perpendicular to the longitudinal direction of the muddler, the muddler tilting device being inserted into the central through hole of the third toothed wheel and being fixed to the third toothed wheel, such that the rotation of the rotor of the fourth electric motor causes the muddler tilting device to rotate, the fourth electric motor being controlled by the electronic card.

The rotation of the muddler tilting device thus allows the muddler head to move on the entire bottom surface of the container so as to reproduce the movement performed by a bartender.

According to a particular feature of the invention, the container holding device comprises two parallel vertical jaws configured to be brought closer to or away from each other by a jaw moving device driven by a fifth electric motor and to hold a container by clamping the jaws on the lateral walls of the container, the fifth electric motor being controlled by the electronic card.

Both jaws thus allow to hold a container in position below the muddler assembly such that, when controlling the muddler by the muddler driving block, the container remains stationary so as to efficiently triturate the ingredients contained in the container.

In addition, such a container holding device with two jaws allows to hold a container of any size in position, within the limits of the maximum spacing between both jaws.

According to a particular feature of the invention, the jaw moving device comprises a frame in which the ends of a first horizontal rod and the ends of a horizontal threaded rod assembly parallel to the first horizontal rod are arranged, the horizontal threaded rod assembly comprising a first threaded rod and a second threaded rod whose thread is opposite the thread of the first threaded rod, the second threaded rod comprising a central longitudinal bore complementary with the first threaded rod and into which a portion of the first threaded rod is fixedly inserted, one of both jaws comprising, at its upper part, two holes into which the first horizontal rod and the first threaded rod are respectively inserted, and the other jaw comprising, at its upper part, two holes into which the first horizontal rod and the second threaded rod are respectively inserted, two ball bearing cylinders being arranged on the first horizontal rod between both jaws and being respectively fixed to both jaws, two threaded nuts respectively complementary with the first and second threaded rods being respectively arranged on the first and second threaded rods and being respectively attached to both jaws, the rotor of the fifth electric motor being connected to the first threaded rod such that the rotation of the rotor of the fifth electric motor causes the first threaded rod to rotate, thereby causing the second threaded rod to rotate, causing both jaws to move closer to or away from each other according to the direction of rotation of the fifth electric motor.

The rotation of the rotor of the fifth electric motor thus causes the first threaded rod to rotate, thereby causing the second threaded rod to rotate, causing both threaded nuts to move on the first and second threaded rods, respectively, such that both jaws are brought closer to or away from each other according to the direction of rotation of the fifth electric motor, both ball bearing cylinders moving, correspondingly to both threaded nuts, respectively, on the first horizontal rod by being driven by both jaws, respectively.

A container located in the container holding device of the automatic muddler system, between both spaced jaws, is thus automatically held in position by means of both jaws brought closer to the lateral walls of the container by the horizontal threaded rod assembly controlled by the fifth electric motor.

According to a particular feature of the invention, the first and second threaded rods are trapezoidal screws and both threaded nuts are trapezoidal nuts. A faster displacement is thus achieved for a determined number of revolutions of the motor.

According to a particular feature of the invention, the automatic muddler system further comprises a container shaking system located in the container holding device, the container shaking system comprising a sixth electric motor whose rotor is connected to a cam connected to one of the ends of an arm, the other end of said arm being connected to the frame of the jaw moving device, said frame comprising at least one hole into which the at least one vertical rod of the device for vertically moving the muddler is inserted, such that the rotation of the rotor of the sixth electric motor causes the container holding device to move to-and-fro and vertically, the sixth electric motor being controlled by the electronic card.

When a sealed cover has been provided, manually or automatically, on the container and the container is held in the container holding device, the container shaking system thus allows to move the container to-and-fro, quickly and vertically so as to mix the ingredients, such as sugar and one or more liquids, contained in the container.

The container shaking system allows to shake the container, preferably more than 250 times per minute, so as to provide an emulsion of the ingredients contained in the container.

According to a particular feature of the invention, the container shaking system further comprises means for holding a cover on the container.

Said holding means thus allow to hold a cover on the container in order to prevent the cover from being separated from the container when shaking the container by the container shaking system.

According to a particular feature of the invention, the means for holding a cover on the container comprise at least two horizontal rails arranged on the inner face of the frame of the jaw moving device and configured to hold the cover and the container together.

The cover and container assembly is thus inserted, at the junction between the cover and the container, in the at least two horizontal rails so as to hold the cover on the container when shaking the container by the container shaking system.

According to a particular feature of the invention, the automatic muddler system further comprises an automatic container conveyor configured to transport a container below the container holding device.

The container is thus automatically transported below the container holding device by the automatic conveyor, said automatic conveyor being also configured to automatically bring the container away from the container holding device at the end of the triturating operation of the ingredients and/or the shaking operation of the container by the automatic muddler system.

The present invention also relates to a cocktail machine comprising an automatic muddler system according to the present invention.

The cocktail machine thus allows to make cocktails, for example, by automatically dosing liquids and/or ingredients in a container, the automatic muddler system then allows to triturate the ingredients contained in the container, and the automatic muddler system can also shake the container so as to mix the ingredients.

To better illustrate the object of the present invention, a preferred embodiment will be described below, for illustrative and non-limiting purposes, in reference to the appended drawings.

In these drawings:

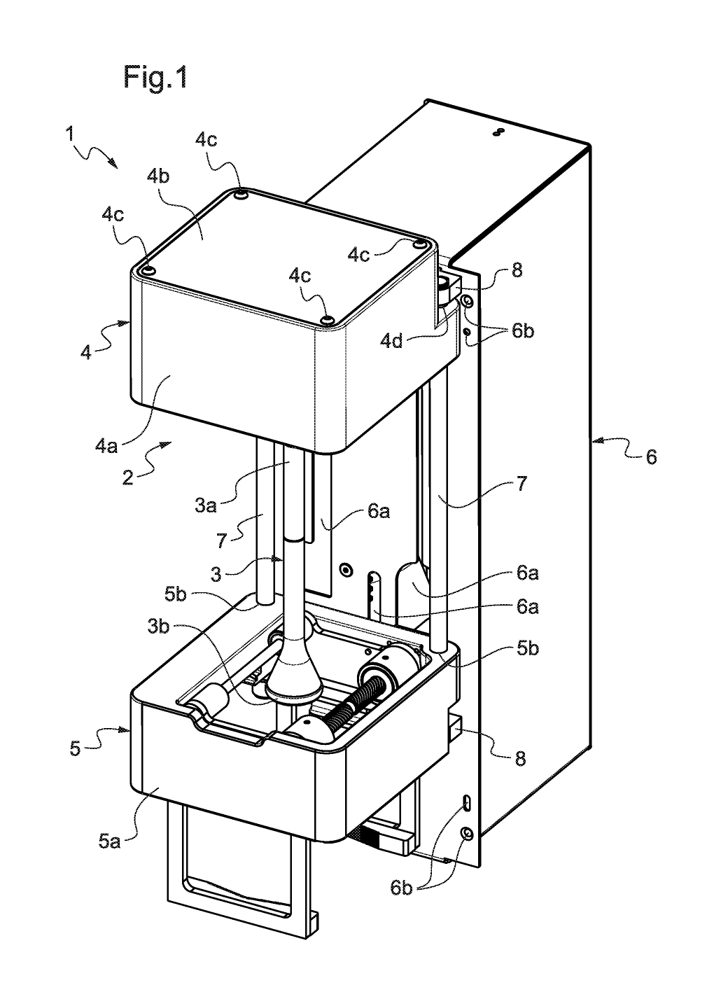

FIG. 1 is a perspective view of an automatic muddler system according to the present invention;

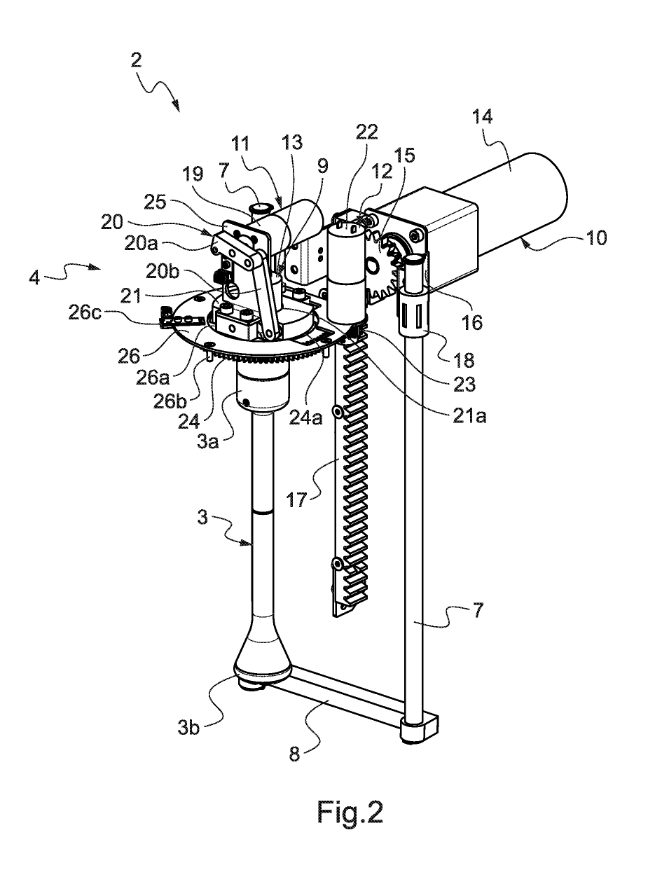

FIG. 2 is a perspective view of the muddler assembly of the automatic muddler system of FIG. 1;

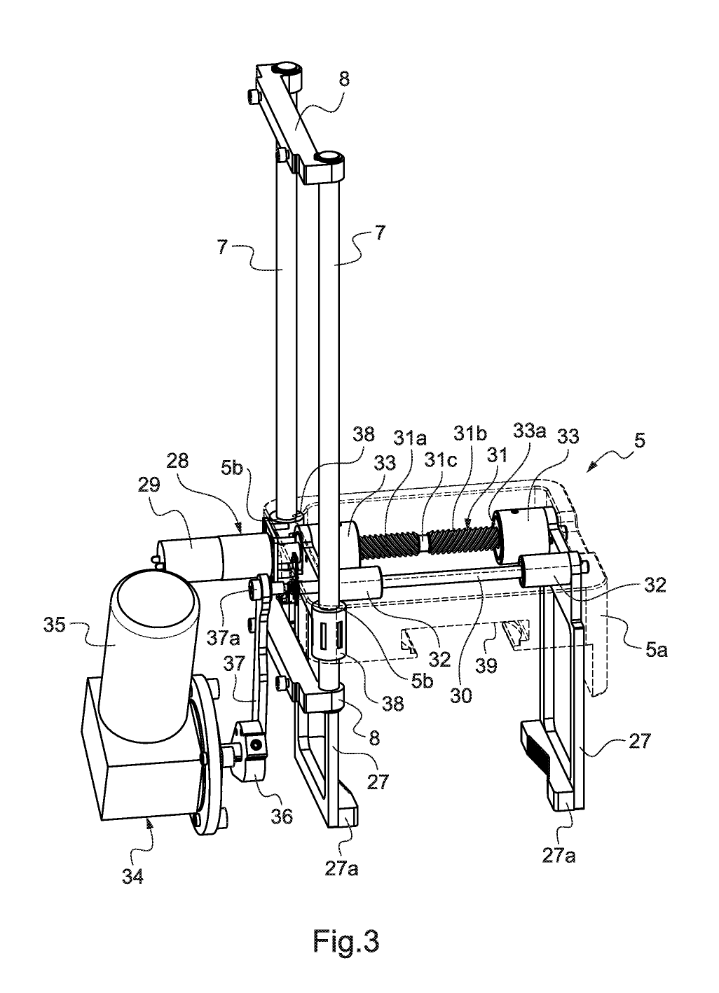

FIG. 3 is a perspective view of the container holding device of the automatic muddler system of FIG. 1;

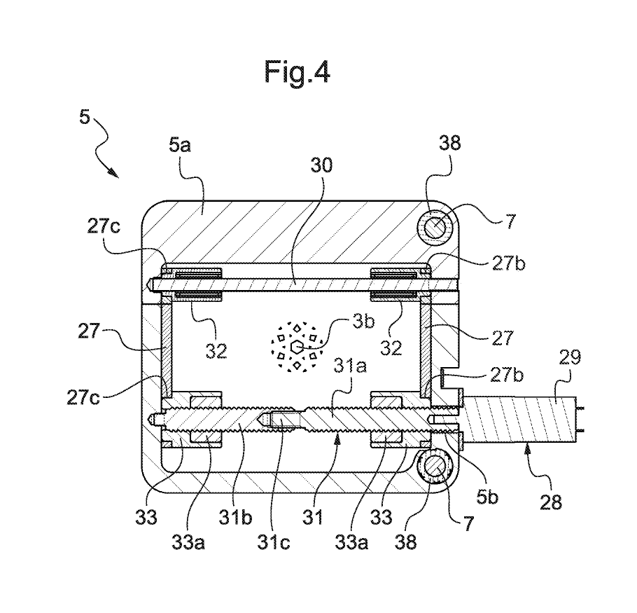

FIG. 4 is a horizontal sectional view of the container holding device of FIG. 3 viewed at the level of the planes containing the first horizontal threaded rod and the horizontal threaded rod assembly; and

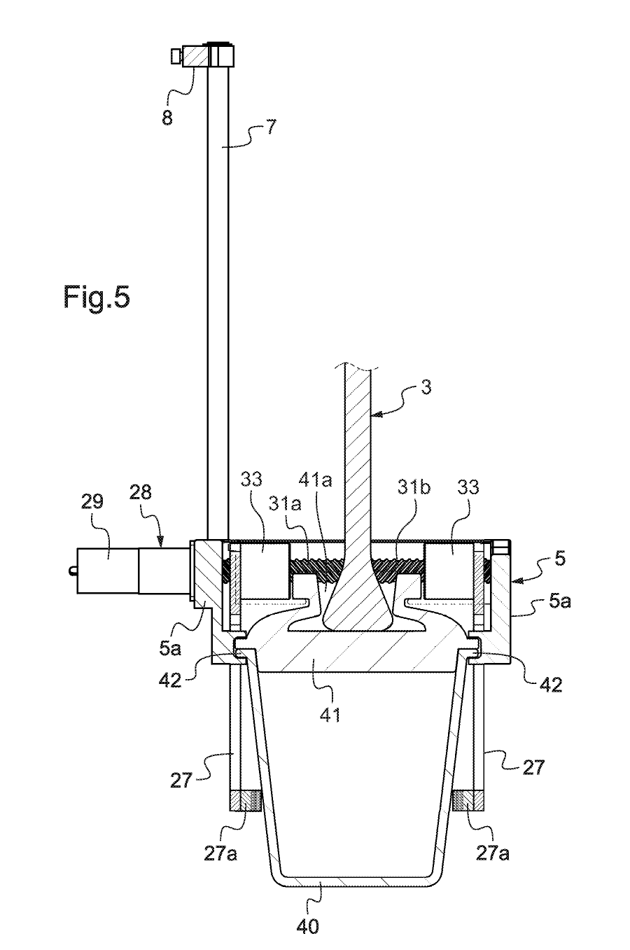

FIG. 5 is a vertical sectional view of a container, with a cover, held in the container holding device of FIG. 3.

If referring to FIG. 1, an automatic muddler system 1 according to the present invention is shown.

The automatic muddler system 1 for triturating ingredients in a container (not shown in FIG. 1) comprises a muddler assembly 2, the muddler assembly 2 comprising a muddler 3 and a muddler driving block 4.

The automatic muddler system 1 further comprises a container holding device 5 (which will be described in more detail in FIG. 3) arranged below the muddler assembly 2 and configured to hold in position, below the muddler 3, a container into which the muddler 3 is intended to triturate ingredients.

The muddler driving block 4 is connected to the upper end 3a of the muddler 3, the head 3b of the muddler 3 being directed away from the muddler driving block 4 in the longitudinal direction of the muddler 3 and being configured to move in use into the container held in the container holding device 5.

The automatic muddler system 1 further comprises a box 6 arranged at the rear of the muddler assembly 2 and of the container holding device 5, the box 6 containing therein an electronic card (not shown in FIG. 1) configured to control the muddler driving block 4 and the container holding device 5, and a power supply (not shown in FIG. 1).

The automatic muddler system 1 further comprises two vertical rods 7 on which the muddler assembly 2 and the container holding device 5 are able to slide, the upper ends and the lower ends of both vertical rods 7 being respectively and fixedly inserted in two horizontal support members 8 connecting both vertical rods 7 to each other, both horizontal support members 8 being fixed on the front face of the box 6 by screwing, welding and/or bonding.

It can be noted that the automatic muddler system 1 could also comprise a single vertical rod 7 or at least three vertical rods 7, without departing from the present invention.

The muddler driving block 4 comprises a lateral wall 4a, an upper wall 4b which is fixed to the lateral wall 4a by screws 4c, and a lower wall (not visible in FIG. 1) which is fixed to the lateral wall 4a by screws.

The lateral wall 4a of the muddler driving block 4 comprises two through holes 4d through which both vertical rods 7 slidably pass, respectively.

The container holding device 5 comprises a frame 5a comprising two through holes 5b through which both vertical rods 7 slidably pass, respectively.

The front face of the box 6 comprises three notches 6a so as to allow the muddler driving block 4 and the container holding device 5 to slide along both vertical rods 7, the front face of the box 6 further comprising holes 6b able to receive screws, for example, for fixing the automatic muddler system 1 on a cocktail machine.

If referring to FIG. 2, the muddler assembly 2 of the automatic muddler system 1 is shown.

It can be noted that the walls of the box 6, the walls 4a, 4b of the muddler driving block 4 and the upper horizontal support member 8 are not shown in FIG. 2 in order to facilitate the understanding of the reader.

The automatic muddler system 1 comprises a device 9 for rotating the muddler on itself, a device 10 for vertically moving the muddler, a muddler tilting device 11 and a device 12 for rotating the muddler tilting device.

The automatic muddler system 1 is thus configured to reproduce the movement performed by a bartender, the device 9 for rotating the muddler on itself and the device 10 for vertically moving the muddler allowing to crush ingredients contained in a container located below the muddler assembly 2 using the muddler head 3b, the muddler tilting device 11 and the device 12 for rotating the muddler tilting device allowing the muddler head 3b to move on the entire bottom surface of the container, regardless of the shape and of the diameter of the bottom of the container, thereby allowing to automatically, evenly and efficiently triturate the ingredients located in the container.

The device 9 for rotating the muddler on itself, the muddler tilting device 11 and the device 12 for rotating the muddler tilting device are arranged in the muddler driving block 4, and the device 10 for vertically moving the muddler is arranged in the box 6.

The electronic card (not shown in FIG. 2) is configured to control the device 9 for rotating the muddler on itself, the device 10 for vertically moving the muddler, the muddler tilting device 11 and the device 12 for rotating the muddler tilting device, the electronic card comprising one of a processor, a microprocessor, a microcontroller, a digital signal processor (DSP), or a programmable logical component such as a field programmable gate array (FPGA) or an application specific integrated circuit (ASIC), and a memory.

It can be noted that the automatic muddler system 1 could also comprise several electronic cards in order to control the different devices, without departing from the scope of the present invention.

The device 9 for rotating the muddler on itself comprises a first electric motor 13 whose rotor is connected to the upper end 3a of the muddler 3 and having, as a rotation axis, the longitudinal direction of the muddler 3, so as to rotate the muddler 3 on itself around its longitudinal axis, the first electric motor 13 being controlled by the electronic card.

The rotation of the muddler 3 on itself around its longitudinal axis thus allows to triturate ingredients contained in a container when the muddler head 3b is lowered on the bottom of the container by the device 10 for vertically moving the muddler.

The rotation speed of the first electric motor 13 is preferably between 50 and 120 rpm.

The device 10 for vertically moving the muddler comprises a second electric motor 14 whose rotor is connected to a first toothed wheel 15 and whose stator is fixed on the lateral wall 4a of the muddler driving block 4 by a U-shaped connecting member 16 screwed on the stator of the second electric motor 14 and on the lateral wall 4a of the muddler driving block 4.

The first toothed wheel 15 meshes with a vertical rack 17 fixed to the box 6 such that the rotation of the rotor of the second electric motor 14 causes the second electric motor 14 to move along the rack 17, thereby causing the muddler driving block 4 to slide along both vertical rods 7, the second electric motor 14 being controlled by the electronic card.

Sliding cylinders 18 are arranged in the muddler driving block 4 by being respectively inserted on both vertical rods 7 so as to guide the muddler driving block 4 sliding along both vertical rods 7.

The fact that the muddler driving block 4 vertically slides along both vertical rods 7 thus allows to lower the muddler head 3b at the bottom of a container and then to perform a vertical to-and-fro movement so as to triturate the ingredients contained in the container.

The rotation speed of the second electric motor 14 is preferably between 40 and 80 rpm.

The muddler tilting device 11 comprises a third electric motor 19 whose rotor is connected to a first arm member 20a of a hinged arm 20, the hinged arm 20 further comprising a second arm member 20b, one end of which is rotatably attached to the first arm member 20a and the other end of which is rotatably attached to a connecting member 21 comprising a through hole 21a into which the upper end 3a of the muddler 3 is inserted, such that the rotation of the rotor of the third electric motor 19 causes the muddler head 3b to be tilted in a vertical plane, the third electric motor 19 being controlled by the electronic card.

The rotation of the rotor of the third electric motor 19 thus causes the muddler 3 to be tilted or swung in a vertical plane from a horizontal axis of the connecting member 21 driven by the hinged arm 20, thereby allowing to tilt the muddler head 3b in the container so as to reach the edges of the bottom of the container to triturate ingredients located on the edges of the container.

The rotation speed of the third electric motor 19 is preferably between 20 and 25 rpm.

The device 12 for rotating the muddler tilting device comprises a fourth electric motor 22 whose rotor is connected to a second toothed wheel 23 meshing with a third toothed wheel 24 with a central through hole 24a, the connecting member 21 of the muddler tilting device 11 being inserted in the central through hole 24a of the third toothed wheel 24 and the third electric motor 19 of the muddler tilting device 11 being fixed to the third toothed wheel 24 by a support plate screwed on the third electric motor 19 and on the third toothed wheel 24, such that the rotation of the rotor of the fourth electric motor 22 causes the muddler tilting device 11 to rotate, the fourth electric motor 22 being controlled by the electronic card.

The rotation of the muddler tilting device 11 thus allows to move the muddler head 3b on the entire bottom surface of the container so as to reproduce the movement performed by a bartender.

Another support plate 26, which is circular and horizontal, is also arranged in the muddler driving block 4 above the third toothed wheel 24, said support plate 26 comprising a central hole 26a into which the device 9 for rotating the muddler on itself and the muddler tilting device 11 are arranged, the fourth electric motor 22 being arranged on the upper part of the support plate 26 with its rotor passing through a hole in the support plate 26 so as to be connected to the second toothed wheel 23.

The support plate 26 is fixed to the lower wall of the muddler driving block 4 by screws 26b and to the lateral wall 4a of the muddler driving block 4 by an attachment 26c, the second toothed wheel 23 and the third toothed wheel 24 lying on the upper part of the lower wall of the muddler driving block 4.

In this preferred embodiment, the third toothed wheel 24 is larger than the second toothed wheel 23, but the second and third toothed wheels 23 and 24 could be identical or the second toothed wheel 23 could be larger than the third toothed wheel 24, without departing from the scope of the present invention.

The rotation speed of the fourth electric motor 22 is preferably between 80 and 120 rpm.

If referring to FIGS. 3 and 4, the container holding device 5 of the automatic muddler system 1 is shown.

The container holding device 5 comprises two parallel vertical jaws 27 configured to be brought closer to or away from each other by a jaw moving device 28 controlled by a fifth electric motor 29 and to hold a container (not shown in FIGS. 3 and 4) by clamping the jaws 27 on the lateral walls of the container, the fifth electric motor 29 being controlled by the electronic card.

It can be noted that the fifth electric motor 29 could also be controlled by another additional electronic card, without departing from the scope of the present invention.

Seals 27a are arranged at the lower parts of both jaws 27 so as to compensate for a potential inclination of the lateral walls of the container being held.

The jaw moving device 28 comprises the frame 5a (shown in dotted lines in FIG. 3) in which the ends of a first horizontal rod 30 and the ends of a horizontal threaded rod assembly 31 parallel to the first horizontal rod 30 are arranged.

The horizontal threaded rod assembly 31 comprises a first threaded rod 31a and a second threaded rod 31b whose thread is opposite the thread of the first threaded rod 31a.

The second threaded rod 31b comprises a central longitudinal bore complementary with the end 31c of the first threaded rod 31a facing the second threaded rod 31b, the corresponding end 31c of the first threaded rod 31a being fixedly inserted in said bore of the second threaded rod 31b, said end 31c having a diameter lower than that of the rest of the first threaded rod 31a.

One of both jaws 27 comprises, at its upper part, two holes 27b into which the first horizontal rod 30 and the first threaded rod 31a are respectively inserted.

The other jaw 27 comprises, at its upper part, two holes 27c into which the first horizontal rod 30 and the second threaded rod 31b are respectively inserted.

Two ball bearing cylinders 32 are arranged on the first horizontal rod 30 between both jaws 27 and respectively attached to both jaws 27 in order to allow the rod 30 to slide therein.

Two cylinders 33, respectively comprising therein two threaded nuts 33a respectively complementary with the first and second threaded rods 31a and 31b, are respectively arranged on the first and second threaded rods 31a and 31b between both jaws 27 and respectively fixed to both jaws 27.

The rotor of the fifth electric motor 29 is connected to the first threaded rod 31a via a hole 5b in the frame 5a and has a rotation axis corresponding to the longitudinal direction of the rod assembly 31, such that the rotation of the rotor of the fifth electric motor 29 causes the first threaded rod 31a to rotate, thereby causing the second threaded rod 31b to rotate, causing both cylinders 33 with threaded nuts 33a to move on the first and second threaded rods 31a and 31b, respectively, such that both jaws 27 move closer to or away from each other according to the direction of rotation of the fifth electric motor 29, both ball bearing cylinders 32 moving, correspondingly to both cylinders 33 with threaded nuts 33a, respectively, on the first horizontal rod 30 by being driven by both jaws 27, respectively.

The first and second threaded rods 31a and 31b are preferably trapezoidal screws, and both threaded nuts 33 are preferably trapezoidal nuts complementary with the trapezoidal screws.

A container located in the container holding device 5 of the automatic muddler system 1, between both spaced jaws 27, is thus automatically held in position by means of both jaws 27 brought closer to the lateral walls of the container by the jaw moving device 28 controlled by the fifth electric motor 29.

The rotation speed of the fifth electric motor 29 is preferably between 20 and 40 rpm.

The container holding device 5 further comprises a container shaking system 34 which comprises a sixth electric motor 35 whose rotor is connected to a cam 36 connected to one of the ends of an arm 37, the other end of said arm 37 being connected to the frame 5a of the jaw moving device 28 by a bolt 37a.

Two sliding cylinders 38 are located in the frame 5a, at the level of the through holes 5b, by being respectively inserted on both vertical rods 7 so as to guide the frame 5a sliding along both vertical rods 7, such that the rotation of the rotor of the sixth electric motor 35 causes the frame 5a of the container holding device 5 to move to-and-fro and vertically, the sixth electric motor 35 being controlled by the electronic card.

It can be noted that the fifth electric motor 35 could also be controlled by another additional electronic card, without departing from the scope of the present invention.

The frame 5a comprises, at the level of one of its lateral walls, a notch 39 forming two opposed rails, the notch 39 being complementary with the shape of a cover able to be arranged on the container, so as to facilitate the introduction of the container with said cover in the container holding device 5.

When a sealed cover has been provided, manually or automatically, on the container and when the container is held in the container holding device 5, the container shaking system 34 thus allows to move the container to-and-fro, quickly and vertically so as to mix the ingredients contained in the container.

The rotation speed of the sixth electric motor 35 is preferably higher than 250 revolutions per minute so as to provide an emulsion of the ingredients contained in the container.

If referring to FIG. 5, a container 40, with a cover 41, held in the container holding device 5 of the automatic muddler system 1 is shown.

The frame 5a of the container holding device 5 comprises three horizontal rails 42 arranged on the three inner lateral walls of the frame 5a other than the lateral wall of the frame 5a comprising the notch 39, the three horizontal rails 42 being configured to receive and hold the cover and the container together.

The container 40 and cover 41 assembly is thus inserted, at its junction between the cover 41 and the container 40, in the three horizontal rails so as to hold the cover 41 on the container 40 when shaking the container 40 by the container shaking system 34.

It can be noted that the frame 5a could comprise only two horizontal rails 42 arranged on two opposed inner lateral walls of the frame 5a, without departing from the scope of the present invention.

In FIG. 5, the container 40 is held by the jaws 27 by its lateral walls after having brought the cylinders with threaded nuts 33 closer to each other, as a result of the rotation of the first threaded rod 31a controlled by the fifth electric motor 29.

The cover 41 is configured such that the container 40 is sealed when the cover 41 is disposed thereon.

The upper part of the cover 41 comprises a recess 41a able to receive the head 3b of the muddler 3, the recess 41a being configured such that the muddler head 3b does not come into contact with the lower part of the cover 41 when the container 40 is shaken by the container shaking system 40.

The automatic muddler system 1 can also comprise an automatic container conveyor (not shown in FIGS. 1-5) configured to transport the container 40 below the container holding device 5, the container 40 thus being automatically transported below the container holding device 5 by the automatic conveyor, said automatic conveyor being also configured to automatically bring the container 40 away from the container holding device 5 at the end of the triturating operation of the ingredients and/or of the shaking operation of the container 40 by the automatic muddler system 1.

The present invention also relates to a cocktail machine comprising an automatic muddler system 1 according to the present invention.

Said cocktail machine thus allows to make cocktails in the container 40, the automatic muddler system 1 then allows to triturate the ingredients contained in the container 40, and the automatic muddler system 1 can also shake the container 40 so as to mix the ingredients contained therein when the cover 41 is provided on the container 40.

1-13. (canceled)

14. An automatic muddler system for triturating ingredients in a container, the automatic muddler system comprising a muddler assembly comprising a muddler, a container holding device for holding in position, below the muddler, a container in which the muddler is to triturate ingredients being located below the muddler, the muddler assembly further comprising a muddler driving block connected to the upper end of the muddler, the head of the muddler being directed opposite from the muddler driving block in the longitudinal direction of the muddler and being configured to move in use in the container held in the container holding device, the muddler driving block comprising a device for rotating the muddler on itself, a device for vertically moving the muddler, an electronic card configured to control the device for rotating the muddler on itself and the device for vertically moving the muddler, and a power supply, wherein the muddler driving block further comprises a muddler tilting device and a device for rotating the muddler tilting device, the muddler tilting device and the device for rotating the muddler tilting device being controlled by said electronic card.

15. The automatic muddler system according to claim 14, wherein the device for rotating the muddler on itself comprises a first electric motor, the rotor of the first electric motor being connected to the upper end of the muddler and having a rotation axis corresponding to the longitudinal direction of the muddler so as to rotate the muddler on itself around the longitudinal axis of the muddler, the first electric motor being controlled by the electronic card.

16. The automatic muddler system according to claim 14, wherein the device for vertically moving the muddler comprises at least one vertical rod on which the muddler driving block is able to slide, and a second electric motor, the rotor of the second electric motor being connected to a first toothed wheel and the stator of the second electric motor being fixed to the muddler driving block, the first toothed wheel meshing with a stationary vertical rack such that the rotation of the rotor of the second electric motor causes the second electric motor to move along the rack, thereby causing the muddler driving block to slide along the at least one vertical rod, the second electric motor being controlled by the electronic card.

17. The automatic muddler system according to claim 14, wherein the muddler tilting device comprises a third electric motor, the rotor of the third electric motor being connected to one of the ends of a hinged arm, the other end of the hinged arm being connected to a connecting member comprising a through hole into which the upper end of the muddler is inserted, such that the rotation of the rotor of the third electric motor causes the muddler head to be tilted, the third electric motor being controlled by the electronic card.

18. The automatic muddler system according to claim 14, wherein the device for rotating the muddler tilting device comprises a fourth electric motor, the rotor of the fourth electric motor being connected to a second toothed wheel meshing with a third toothed wheel with a central through hole, the second and third toothed wheels being located in a plane perpendicular to the longitudinal direction of the muddler, the muddler tilting device being inserted into the central through hole of the third toothed wheel and being fixed to the third toothed wheel, such that the rotation of the rotor of the fourth electric motor causes the muddler tilting device to rotate, the fourth electric motor being controlled by the electronic card.

19. The automatic muddler system according to claim 14, wherein the container holding device comprises two parallel vertical jaws configured to be brought closer to or away from each other by a jaw moving device driven by a fifth electric motor and to hold a container by clamping the jaws on the lateral walls of the container, the fifth electric motor being controlled by the electronic card.

20. The automatic muddler system according to claim 19, wherein the jaw moving device comprises a frame in which the ends of a first horizontal rod and the ends of a horizontal threaded rod assembly parallel to the first horizontal rod are arranged, the horizontal threaded rod assembly comprising a first threaded rod and a second threaded rod, the thread of the second threaded rod being opposite the thread of the first threaded rod, the second threaded rod comprising a central longitudinal bore complementary with the first threaded rod and into which a portion of the first threaded rod is fixedly inserted, one of both jaws comprising, at its upper part, two holes into which the first horizontal rod and the first threaded rod are respectively inserted, and the other jaw comprising, at its upper part, two holes into which the first horizontal rod and the second threaded rod are respectively inserted, two ball bearing cylinders being arranged on the first horizontal rod between both jaws and being respectively fixed to both jaws, two threaded nuts respectively complementary with the first and second threaded rods being respectively arranged on the first and second threaded rods and being respectively attached to both jaws, the rotor of the fifth electric motor being connected to the first threaded rod such that the rotation of the rotor of the fifth electric motor causes the first threaded rod to rotate, thereby causing the second threaded rod to rotate, causing both jaws to move closer to or away from each other according to the direction of rotation of the fifth electric motor.

21. The automatic muddler system according to claim 20, wherein the first and second threaded rods are trapezoidal screws and both threaded nuts are trapezoidal nuts.

22. The automatic muddler system according to claim 20, wherein the automatic muddler system further comprises a container shaking system located in the container holding device, the container shaking system comprising a sixth electric motor, the rotor of the sixth electric motor connected to a cam connected to one of the ends of an arm, the other end of said arm being connected to the frame of the jaw moving device, the frame comprising at least one hole into which the at least one vertical rod of the device for vertically moving the muddler is inserted, such that the rotation of the rotor of the sixth electric motor causes the container holding device to move to-and-fro and vertically, the sixth electric motor being controlled by the electronic card.

23. The automatic muddler system according to claim 22, wherein the container shaking system further comprises means for holding a cover on the container.

24. The automatic muddler system according to claim 23, wherein the means for holding a cover on the container comprise at least two horizontal rails arranged on the inner face of the frame of the jaw moving device and configured to hold the cover and the container together.

25. The automatic muddler system according to claim 14, wherein the automatic muddler system further comprises an automatic container conveyor configured to transport a container below the container holding device.

26. cocktail machine comprising an automatic muddler system according to claim 14.
